(19) United States
(12) Patent Application Publication
(10) Pub. No.: US 2009/0004563 A1
(43) Pub. Date: Jan. 1, 2009

(54) SUBSTITUTED LITHIUM TITANATE SPINEL COMPOUND WITH IMPROVED ELECTRON CONDUCTIVITY AND METHODS OF MAKING THE SAME

(76) Inventor: Zhimin Zhong, Strongsville, OH (US)

Correspondence Address: AMIN, TUROCY & CALVIN, LLP, 127 Public Square, 57th Floor, Key Tower, CLEVELAND, OH, 44114, US

(21) Appl. No.: 11/770,291

(22) Filed: Jun. 28, 2007

(51) Int. Cl. H01M 4/48; C01G 23/00; C01G 37/00; C01F 17/00; H01M 10/36

(52) U.S. Cl. 429/188; 423/598; 423/596; 423/263

(57) ABSTRACT

Materials with improved electron conductivity for use in rechargeable lithium ion electrochemical cells include, but are not limited to, lithium titanate spinels of the formula Li₄Ti₅O₁₂ wherein a portion of Ti is replaced with one or more substitution ions of transition metals. The substitution ions are not in their highest oxidation states and have free valence electrons thereby increasing electron conductivity. The lithium titanate spinels with substitution ions have an unchanged crystal lattice structure and the substitution ions occupy the same crystal lattice sites as Ti. Solid state and polymerized complex methods of synthesizing spinels in addition to rechargeable lithium ion batteries utilizing the improved materials are also disclosed.

### TECHNICAL FIELD

Described here are electrode materials for use in rechargeable lithium ion electrochemical cells and electrochemical capacitors.

### BACKGROUND

Rechargeable lithium ion batteries are used widely in consumer electronics such as camcorders, cell phones and laptop computers. Rechargeable lithium ion batteries employing graphite or other carbonaceous materials as the active ingredient for anodes have an insufficient power density for high-power applications such as electric vehicles, hybrid electric vehicles, and power tools. Further, using carbonaceous materials as anode insert materials requires the formation of solid electrolyte interphase between the anode and electrolyte, which makes operation unsafe at temperatures above 60° C.

Anodes formed from lithium titanate spinel, Li₄Ti₅O₁₂, have been used as an alternative to carbonaceous materials due to higher safety at elevated temperatures as well improved charge/discharge rates. During charging/discharging, anodic lithium titanate spinel undergoes a lithium intercalation/de-intercalation reaction described as follows:

Li₄Ti₅O₁₂+3Li⁺+3Li⁺+3e⁻⇄Li₇Ti₅O₁₂ (1)

Li₄Ti₅O₁₂ spinels display good lithium ion storage capacity and lithium ion conductivity, however, Li₄Ti₅O₁₂ spinels display inadequate conductance of electrons. In Li₄Ti₅O₁₂ spinels, Ti ions are in their highest oxidation state, 4+, and no free valance electrons are present. Therefore, conductance of electrons and power density are adversely affected. Prior art approaches have attempted to address this problem by combining a fine powder of Li₄Ti₅O₁₂ spinel material with conductive carbon material to reduce a distance that electrons pass through resistive Li₄Ti₅O₁₂ spinel material. However, such an approach has the drawback of increasing anode size; therefore, the energy density of the lithium ion cell is less than optimal. Mg²⁺ substituted spinels of the type Li₄₋ₓMgₓTi₅O₁₂, wherein some Ti⁴⁺ ions are reduced to Ti³⁺ ions to provide some free valence electrons, have also been proposed to address the problem of reduced conductance of electrons in lithium titanate spinels. However, the crystal form of Mg²⁺ substituted spinels, Li₄₋ₓMgₓTi₅O₁₂, reduces lithium intercalation rates. Coating the surface of Li₄Ti₅O₁₂ spinel anodes with a conductive TiN coating has also been proposed. However, such an approach is difficult to employ on a large scale and only increases conductivity on the surface of the electrode while the high resistance of the Li₄Ti₅O₁₂ spinel core remains.

### BRIEF SUMMARY OF THE DRAWING

FIG. 1 illustrates a flowchart for the preparation of lithium titanate spinels substituted with molybdenum utilizing a polymerized complex method in accordance with one aspect of the invention.

FIG. 2 displays Cu—Kα x-ray powder diffraction data illustrating temperature dependence of a phase formation process for Li₂Ti₄MoO₁₂ in accordance with one aspect of the invention.

FIG. 3 displays Cu—Kα x-ray powder diffraction data illustrating temperature dependence of a phase formation process for Li₄Ti_{4.5}Mo_{0.5}O₁₂ in accordance with one aspect of the invention.

FIG. 4 displays an embodiment of a rechargeable lithium ion battery with an anode comprising substituted lithium titanate spinels in accordance with one aspect of the invention.

### SUMMARY

The following presents a simplified summary in order to provide a basic understanding of some aspects of the invention. This summary is not an extensive overview of the invention. It is intended to neither identify key or critical elements of the invention nor delineate the scope of the invention. Rather, the sole purpose of this summary is to present some concepts of the invention in a simplified form as a prelude to the more detailed description that is presented hereinafter.

The subject invention provides for novel spinels for use in anodes of rechargeable lithium ion batteries. The novel spinels have both high lithium ion conductance and high electron conductance. Methods for making the novel spinels and an electrochemical cell employing the novel spinels are also disclosed.

One aspect of the invention relates to electrodes containing a lithium titanate spinel with a general formula Li₄Ti_{5-Z}M¹_{z1}M²_{z2}M³_{z3} . . . M^{k}_{zk}O₁₂ and other formulae described herein. Z has a value from about 0.1 to about 2.5 and Z is equal to the sum of Z=z1+z2+z3+. . . zk. Further, z1, z2, z3, . . . z1 independently have a value from about 0 to about 2.5. M¹, M², M³, . . . M^{k} are cations independently transitional metals.

Another aspect of the invention relates to a rechargeable lithium ion battery with an anode and/or cathode containing a lithium titanate spinel described herein, an electrolyte comprising a lithium salt allowing for lithium ion conductance between the anode and the cathode, and a lithium-permeable separator located between the anode and the cathode.

Yet another aspect of the invention relates to methods for making lithium titanate spinels contained herein. Titanium oxide, lithium titanate spinel, and a lithium metal oxide and/or lithium metal oxide salt both containing one or more transition metals are brought into contact and then heated under a hydrogen containing atmosphere. Further, the titanium oxide, lithium titanate spinel, and a lithium metal oxide and/or lithium metal oxide salt can be brought into contact using a polymerized complex method. A titanium (IV) alkoxide, a polyalcohol, and a metal oxide, metal oxide salts, metal carbonate, and/or a metal alkoxide where the metal is a transition metal are combined in a solution. The solution is heated and then an acid and a salt are added. The solution is then heated such that a polyesterification reaction occurs between the acid and the polyalcohol to form a polymerized precursor product. The polymerized precursor product is then heated under an atmosphere containing air.

To the accomplishment of the foregoing and related ends, the invention comprises the features hereinafter fully described and particularly pointed out in the claims. The following description and the annexed drawings set forth in detail certain illustrative aspects and implementations of the invention. These are indicative, however, of but a few of the various ways in which the principles of the invention may be employed. Other objects, advantages and novel features of the invention will become apparent from the following detailed description of the invention when considered in conjunction with the drawings.

### DETAILED DESCRIPTION

High lithium ion conductance, high electron conductance, fast lithium ion intercalation rate, and increased power density are achieved through the use of a genus of novel spinels. One aspect of the invention is the use of novel, substituted lithium titanate spinels that have an isomorphous crystal lattice occupancy in comparison to Li₄Ti₅O₁₂ spinel. Another aspect of the invention is that substituting ions are either aliovalent or isovalent to Ti⁴⁺ and are not in their highest oxidation state, or the substitution forces part of titanium to 3+ oxidation state; therefore, the substitution ions have free valence electrons.

The substituted spinels have the general formula Li₄Ti₅₋ₓMₓO₁₂, where x has a value from about 0.1 to about 2.5 and M is one or more selected from the group of V, Cr, Nb, Mo, Ta, and W. In another embodiment, x has a value from bout 0.5 to about 2. In yet another embodiment, x has a value from about 0.9 to about 2. A method of making the substituted lithium titanate spinels by mixing of commercially available starting materials followed by reduction into a phase pure spinel in the presence of a partial hydrogen atmosphere and heat is disclosed. Also disclosed is a rechargeable lithium ion battery with an anode containing the substituted lithium titanate spinels.

Spinels have the general formula AB₂O, wherein the A and B cations are distinguished by their positions in a crystal lattice and/or crystal structure. The crystal structure of spinels are described by a Space Group with a Herman-Mauguin Symbol Fd3m, wherein each unit cell has 64 tetrahedral interstices situated at three crystallographically non-equivalent octahedral sites (Wyckoff sites) 8a, 8b and 48f, and 32 octahedral sites situated at two crystallographically non-equivalent sites 16c and 16d. Notation is in accordance with the International Tables of Crystallography. In an AB₂O spinel, the A cations reside in the 8a tetrahedral sites and the B cations reside in the 16d octahedral sites. The O²⁻ anions form a tightly packed lattice and are located in the 32e sites. Lithium ions moving in and out of the lattice must move through the tightly packed lattice of O²⁻ anions. Alternatively, Li₄Ti₅O₁₂ spinels can be written in the form Li[Li_{1/3}Ti_{5/3}]O₄ for comparison to the general spinel formula AB₂O. The cations in AB₂O spinels are distributed as follows:

TABLE 1

| Ion | Site | Occupancy |
|---|---|---|
| Li⁺ (75% of Li⁺ ions) | 8a | All sites |
| Li⁺ (25% of Li⁺ ions) | 16d | Random sites |
| Ti⁴⁺ | 16d | Random sites |

Upon lithium ion intercalation to form a Li₇Ti₅O₁₂ spinel, the ion distribution changes to the following:

TABLE 2

| Ion | Site | Occupancy |
|---|---|---|
| Li⁺ (6 of 7) | 16c | All sites |
| Li⁺ (1 of 7) | 16d | Random sites |
| Ti³⁺ (3 of 5 Ti total) | 16d | Random sites |
| Ti⁴⁺ (2 of 5 Ti total) | 16d | Random sites |

The three incoming lithium ions (Eq. 1) occupy 16c sites while the lithium ions that were occupying 8a sites in the Li₄Ti₅O₁₂ spinel move to 16c sites. The 8a and 16c interstices serve as interstitial space for lithium ion transport and occupancy. Without wishing to be bound by any theory, it is believed that the occupancy of only lithium ions in the 8a and 16c sites assists the transport of lithium ions through the tightly packed O²⁻ anion lattice thus accounting for high lithium ion intercalation rates.

Li_{4-y}Mg_{y}Ti₅O₁₂ spinel has been prepared by Chen et al., 148 J. ELECTROCHEM. Soc. A102 (2001), which is incorporated by reference, wherein Mg²⁺ substitutes for a portion of lithium ions in Li₄Ti₅O₁₂ spinels to form a spinel of the formula Li_{4-y}Mg_{y}Ti₅O₁₂, where y can be an integer or non-integer. Since lithium ions and Mg²⁺ ions are aliovalent, a portion of the Ti⁴⁺ normally present in Li₄Ti₅O₁₂ spinels are reduced to Ti³⁺ as a requirement to maintain neutral charge; Ti³⁺ ions provide free valence electrons to support electron conductivity. However, Li_{4-y}Mg_{y}Ti₅O₁₂ spinels have inadequate lithium ion intercalation rates. Physical studies indicate that a portion of substituting Mg²⁺ ions occupy 8a sites, thereby inhibiting lithium ion transport through those sites. Therefore, any benefit of increased electron conductance is abrogated by low power density due to poor lithium intercalation rates.

The invention provides a novel substituted lithium titanate spinel of the form Li₄Ti₅₋ₓMₓO₁₂, where the identity of M and the quantity x have been described above. Unlike Li_{4-y}Mg_{y}Ti₅O₁₂ spinels, the subject Li₄Ti₅₋ₓMₓO₁₂ spinels have a third cation, M, substituting for Ti⁴⁺. Substitution of Ti⁴⁺ with M provides for increased electronic conductivity and high lithium ion intercalation rates provided that two conditions are satisfied:

1. the substituting M ions occupy the same 16d sites as the Ti⁴⁺ ions being replaced, providing for an isomorphic occupancy of a crystal lattice in comparison to Li₄Ti₅O₁₂ spinel; and

2. the substituting M ions are not in their highest oxidation state, or the substituting M ions are in their highest oxidation state and part of Ti are in 3+ oxidation state, and therefore, provide free valence electrons to enhance electron conductivity.

One or more of the ions of elements V, Cr, Nb, Mo, Ta, and W fit the required two criteria by having a highest oxidation state more than 4+, having a stable oxidation state or states from about 3+ to about 6+, and having ionic radii close to that of Ti⁴⁺. The effective ionic radius of octahedral coordinated, low-spin Ti⁴⁺ ion is 0.745 Å based on the ionic radius of octahedral O²⁻ being 1.40 Å; ions with an equivalent effective ionic radius from about 0.68 to about 0.85 Å are considered to be close to the value for Ti⁴⁺. Shannon and Prewitt, B25 ACTA CRYSTALLOGRAPHICA 925 (1969), which is incorporated by reference, discusses the relevant values of effective ionic radii.

The substituting cations, M, in Li₄Ti₅₋ₓMₓO₁₂ spinels can be isovalent or aliovalent to Ti⁴⁺. In another embodiment, M is Mo⁴⁺, where Mo⁴⁺ has two free valance electrons. In Li₄Ti₅₋ₓMoₓO₁₂ spinels, all or substantially all Ti remains in a 4+ oxidation state and free electrons to support electron conductivity are provided by Mo⁴⁺.

Synthesis of substituted lithium titanate spinels typically involves reduction of high oxidation state ions. In some situations where Ti ions are more readily reduced than M ions, synthesis of an isovalent substituted Li₄Ti₅₋ₓMₓO₁₂ spinel may not be possible since a portion of Ti will adopt a 3+ oxidation state while a portion of M ions will adopt a 5+ or higher oxidation state. However, isovalent substitution or aliovalent substitution does not malce a critical difference so long as one or both of a portion of Ti ions and M ions have free valence electrons. Another specific embodiment of the invention is spinel of the formula Li₄Ti₅₋ₓNbₓO₁₂, wherein a portion of Nb has a 5+ oxidation state and a portion of Ti has a 3+ oxidation state; both Nb⁴⁺ and Ti³⁺ introduce free valence electrons to a conductivity band for improved electron conductivity.

Those skilled in the art will recognize that minor changes can be made to spinels of the formula Li₄Ti₅₋ₓMₓO₁₂ while remaining fully functional and providing high lithium ion conductivity and high electron conductivity. M can comprise more than one ionic species. For example, M can comprise a mix of Mo⁴⁺ and V⁴⁺, Mo⁴⁺ and Nb⁴⁺, or any other combination of ions selected from ions of elements V, Cr, Nb, Mo, Ta, and W. Such spinels can be described by M representing a heterogeneous cation/multiple species of cations in the formula Li₄Ti₅₋ₓMₓO₁₂. Alternatively, the equivalent formula Li₄Ti_{5-Z}M¹_{z1}M²_{z1}M³_{z3} . . . M^{k}_{zk}O₁₂ can be used, where M¹, M², M³, . . . M^{k} are independently selected from ions of ions elements V, Cr, Nb, Mo, Ta, and W and Z, z1, z2, z3, . . . zk are selected to satisfy the equation Z=z1+z2+z3+ . . . zk, where Z has a value from about 0.1 to about 2.5 and z1, z2, z3, . . . zk independently have a value from about 0 to about 2.5. In another embodiment, Z has a value from about 0.5 to about 2 and z1, z2, z3, . . . zk independently have a value from about 0.5 to about 2. In yet another embodiment, Z has a value from about 0.9 to about 2 and z1, z2, z3, . . . zk independently have a value from about 0.9 to about 2. For the purposes of this disclosure, the formulae Li₄Ti₅₋ₓMₓO₁₂ and Li₄Ti_{5-Z}M¹_{z1}M²_{z2}M³_{z3} . . . M^{k}_{zk}O₁₂ are completely equivalent; the formula Li₄Ti_{5-Z}M¹_{z1}M²_{z2}M³_{z3} . . . M^{k}_{zk}O₁₂ is useful for its ability to convey the degree of heterogeneity of the substituting cation efficiently. Further, M and M¹, M², M³ . . . M^{k} have an average oxidation state in the range of at least about 3+ and at most about 6+. Alternatively, M and M¹, M², M³ . . . M^{k} have an average oxidation state in the range of at least about 4+ and at most about 5+.

Those skilled in the art will recognize that the amount of lithium ion in a substituted lithium titanate spinel can be decreased in according to a general formula of lithium titanate spinel Li₃₊ₐTi₆₋ₐO₁₂, where a has a value from 0 to 1. The decrease was reported by Deschanvers et al, 6 Mater. Res. Bull. 699 (1971), which is incorporated herein by reference. For example, spinels of the formula Li₄Ti₅₋ₓMₓO₁₂ may be described by the more general formula Li₃₊ₐTi₆₋ₐ₋ₓMₓO₁₂, where a has a value from about 0 to about 1 and the quantity x has the values defined above.

Those skilled in the art will recognize that a portion of Ti in substituted lithium titanate spinels can be substituted with ions that do not have free valance electrons provided that at least one specie of ion selected from the elements V, Cr, Nb, Mo, Ta, and W is present as well. For example, the spinel can contain one or more the ions selected from Ze, Ce, Si, and Ge. More specifically, the spinel can contain one or more ions of elements Ze, Ce, Si, and Ge with an average formal oxidation state from about 3+ to about 4+. Ions of elements Ze, Ce, Si, and Ge can be present as impurities or deliberately added to change the conductive properties of a spinel. Spinels of the invention containing ions of elements Ze, Ce, Si, and Ge can be represented by the formulae Li₄Ti₅₋ₓMₓB_{b}O₁₂ and/or Li₃₊ₐTi_{6-a-x-b}MₓB_{b}O₁₂, where B is one or more ions of elements Ze, Ce, Si, and Ge, a and x have the values described above and b has a value from about 0 to about 2. Alternatively, b has a value from about 0.2 to about 1.5. Still alternatively, b has a value from about 0.4 to about 1.2. Further, B has an average oxidation state from about 3+ to about 4+.

Those skilled in the art will recognize that a portion of a crystal lattice of a spinel can contain Mg²⁺ while still having satisfactory electron conductance and/or lithium ion conductance. A spinel of the invention containing Mg²⁺ can be represented by the formula Li_{4-c}Mg_{c}Ti₅₋ₓMₓO₁₂, where c has a value from about 0 to about 1.5 and x has the value described above. Alternatively, c has a value from about 0 to about 1. Still alternatively, c has a value from about 0 to about 0.5.

In order to further illustrate the subject invention, the following examples are provided. The particular compounds and processes and conditions utilized in the examples are meant to be illustrative of the invention and not limiting thereto. Unless otherwise indicated in the following examples and elsewhere in the specification and claims, all parts and percentages are by weight, all temperatures are in degrees Centigrade, and pressure is at or near atmospheric pressure.

Examples 1 though 4 below demonstrate the synthesis of substituted lithium titanate spinels using a polymerized complex technique. The polymerized complex technique typically requires the following acts: 1) forming a solution of at least one species of titanium (IV) alkoxide, such as titanium (IV) isopropoxide, one or more species of polyalcohols, and at least one selected from the group of metal oxides, metal oxide salts, metal carbonates, and metal alkoxides all comprising at least one cation of the elements V, Cr, Nb, Mo, Ta, and W; 2) heating the solution at a temperature less than about 100° C.; 3) adding at a temperature less than about 100° C. one or more species alpha-hydroxycarboxylic acids, such as citric acid, lactic acid and glyolic acid; and a lithium salt such as lithium acetate; 4) heating the solution to a temperature of at least about 105° C. to at most about 180° C. such that a polyesterification reaction occurs between the alpha-hydroxycarboxylic acids and the polyalcohols; 5) heating a polymerized precursor product of the polyesterification reaction (comprising at least one species of titanium (IV) alkoxide, a metal oxide comprising at least one substituting metal ion, and titanium oxide in contact with each other) to a temperature of at least about 400° C. to at most about 750° C. under an atmosphere comprising air; and 6) heating the precursor product to a temperature of at least about 600° C. to at most about 1100° C. under an atmosphere comprising about 0.1% to about 50% hydrogen and at least one selected from the group of nitrogen and noble gases.

### EXAMPLE 1

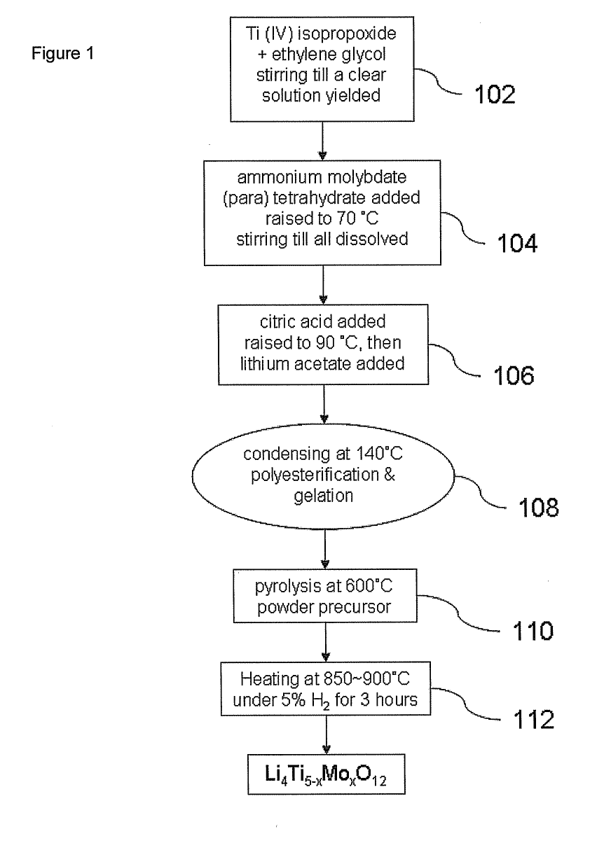

Referring to FIG. 1, Li₄Ti₄MoO₁₂ was synthesized using a polymerized complex method. For each mole of Li₄Ti₄MoO₁₂ desired, synthesis was carried out in a volume of 120 moles of ethylene glycol and 16 moles of citric acid, which serve both as solvents and as reactants. In Act 102, an appropriate stoichiometric quantity of titanium (IV) isopropoxide was added to an appropriate volume of ethylene glycol and stirred until a clear solution is obtained. In Act 104, a molar quantity of ammonium molybdate (para) tetrahydrate equal to 1/28th the amount of titanium (IV) isopropoxide in Act 102 was added to the solution. The temperature of the solution was raised to 70° C. and stirred until all solids were dissolved. In Act 106, the citric acid was added and then the temperature of the solution was raised to 90° C. After the addition of citric acid, a molar amount of lithium acetate equal to the quantity of titanium (IV) isopropoxide in Act 102 was added to the solution, and the solution was stirred at 90° C. for one hour until the solution became a light yellow color and transparent. In Act 108, esterification and polymerization was conducted by raising the solution to 140° C. Over several hours, the solution became viscous and darker yellow in color, and then gelled into a transparent brown glassy resin. There was no visible formation of precipitation or turbidity. A dry polymer resin was obtained by heating from about 180 to 200° C. to evaporate excess ethylene glycol. In Act 110, the dry polymer resin was charred in a furnace at 600° C. with stagnant air to yield the precursor for Li₄Ti₄MoO₄, which contains several crystalline phases. In Act 112, the precursor was calcined under humidified 5% hydrogen with balance of argon at 900° C. for three hours to produce crystalline phase pure Li₄Ti₄MoO₄ spinel.

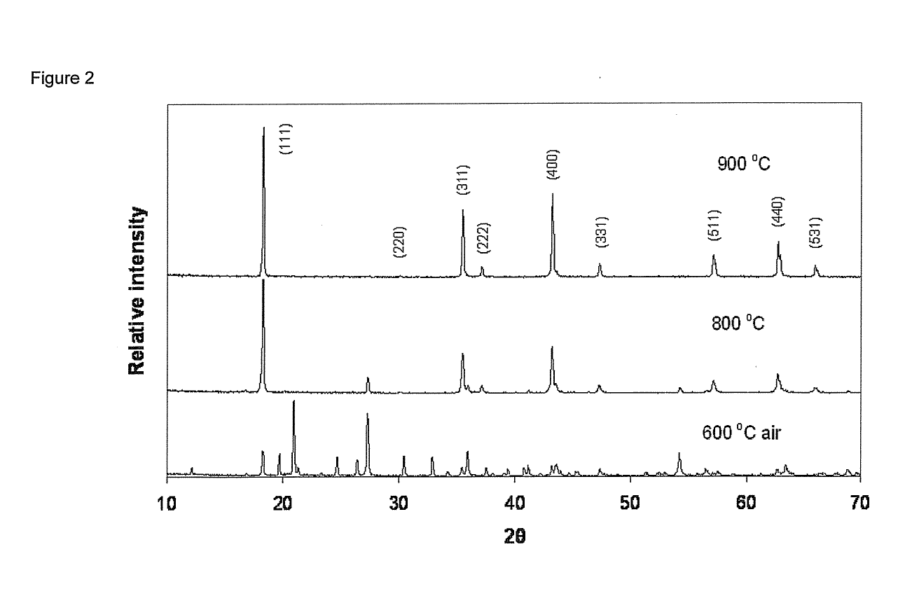

The progress for the formation of one phase of Li₄Ti₄MoO₄ spinel is shown via powder x-ray diffraction (XRD) data in FIG. 2 using Cu—Kα x-ray radiation. After Act 110, charring at 600° C., the XRD data matched the crystal structure for a mixture of Li₂MoO₄, TiO₂, and Li₄Ti₅O₁₂. After the 110 heating Act under air, all Mo existed in a maximum 6+ oxidation state. After heating under partial hydrogen atmosphere at 800° C., the spinel was the major phase with a minor phase of TiO₂ still evident in the XRD data. The heating Act 112 under a partial hydrogen atmosphere at 900° C. yields a crystalline phase pure Li₄Ti₄MoO₄ spinel, as show in FIG. 2. All peaks in FIG. 2 can be indexed according the Joint Committee on Powder Diffraction Standards (JCPDS) number 26-1198, which is evidence that the prepared Li₄Ti₄MoO₄ spinel has the same crystal structure as Li₄Ti₅O₁₂ spinel. Peaks are labeled according to their respective index numbers, which is representative of discrete crystal planes. The intensity of the peak indexed to crystal plane 220 around a 2θ of 30.2° is determined by the scattering power of the cations at the 8a interstices. As the peak (220) is weak and at least less than 1/50^{th} of the intensity of a peak around a 2θ of 18.4° and indexed to crystal plane 111, Mo⁴⁺ and Ti⁴⁺ ions are likely to reside at 16d interstices instead of 8a interstices. The data in FIG. 2 show that a phase pure crystalline form of Li₄Ti₄MoO₁₂ spinel was obtained.

The transformation of the precursor for Li₄Ti₄MoO₄ can be expressed by the following overall reaction:

Li₂MoO₄+1.5TiO₂+0.5Li₄Ti₅O₁₂+H₂→Li₄Ti₄MoO₁₂+H₂O (2)

Acts 102 through 110 form the precursor comprising Li₂MoO₄, TiO₂, and Li₄Ti₅O₁₂. Act 112 coverts the precursor to Li₄Ti₄MoO₁₂ spinel.

### EXAMPLE 2

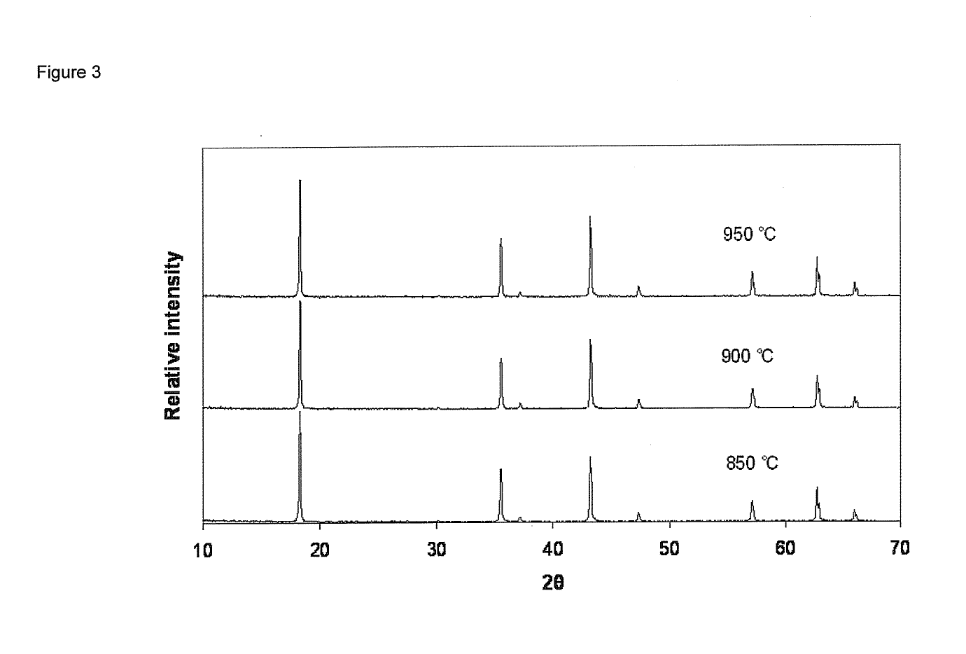

Li₄Ti_{4.5}Mo_{0.5}O₁₂ spinel was synthesized in the same manner as Example 1 except the stoichiometric amounts of titanium (IV) isopropoxide and ammonium molybdate (para) tetrahydrate used were adjust to reflect the stoichiometry of the formula Li₄Ti_{4.5}Mo_{0.5}O₁₂. Upon charring at 600° C. (Act 110), the precursor for Li₄Ti_{4.5}Mo_{0.5}O₁₂ spinel was also a mixture of Li₂MoO₄, TiO₂, and Li₄Ti₅O₁₂. Li₄Ti_{4.5}Mo_{0.5}O₁₂ spinel can be readily phase purified, as shown by the XRD data in FIG. 3, by annealing the precursor under humidified 5% hydrogen with a balance of argon between about 850 and 900° C. for three hours. As shown in FIG. 3, the intensity of the peak indexed to crystal plane 220 around a 2θ of 30.2° is weak; Mo⁴⁺ and Ti⁴⁺ ions are likely to reside at 16d interstices instead of 8a interstices, which is the preferred structure for maintaining high lithium ion intercalation rates. The data presented in FIG. 3 show that a phase pure crystalline form of Li₄Ti_{4.5}Mo_{0.5}O₁₂ was obtained.

### EXAMPLE 3

The synthesis of Li₄Ti_{3.5}Mo_{1.5}O₁₂ spinel can also be undergone using the same method as Examples 1 and 2, and also yields a precursor consisting of Li₂MoO₄, TiO₂, and Li₄Ti₅O₁₂. However, the synthesis of phase pure Li₄Ti_{3.5}Mo_{1.5}O₁₂ spinel has been difficult. While a phase of Li₄Ti^{3.5}Mo_{1.5}O₁₂ phase is formed upon heating the precursor under a humidified 5% hydrogen atmosphere with a balance of argon, a secondary phase of TiO₂ persisted when heating was done at 800° C. When heating was done at 850° C., a monoclinic phase of Li₄Mo₅O₁₂ (described by JCPDS number 21-518) persisted as a secondary phase. Therefore, there is a limitation on how much M⁴⁺ can substitute for Ti⁴⁺ in Li₄Ti₅ μMₓO₁₂. For Mo⁴⁺, the limit is around 30%.

### EXAMPLE 4

Li₄Ti₅₋ₓVₓO₁₂ and specifically Li₄Ti_{4.5}V_{0.5}O₁₂ was prepared using acts identical to those of Examples 1 and 2 except NH₄VO₃ is substituted for ammonium molybdate (para) tetrahydrate, and stoichiometric amounts were adjusted accordingly. All other acts are the same as Examples 1 and 2 and FIG. 1.

Those skilled in the art will easily recognize that there are alternate methods for synthesizing Li₄Ti₅₋ₓMₓO₁₂ spinels other than the polymerized complex technique. These methods include other synthetic techniques such as precipitation, spray drying, freeze drying, sol-gel, combustion synthesis. Specifically, solid state synthesis can be a cost effective approach. Solid state synthesis is accomplished by mixing an appropriate ratio of oxides, carbonates, hydroxides, etc. in appropriate ratios. Specifically, titanium oxide, lithium titanium spinel, and a lithium metal oxide salt comprising one or more ions selected from the group of V, Cr, Nb, Mo, Ta, and W are combined. The mixture is heated at a temperature of at least about 600° C. to at most about 1100° C. under an atmosphere comprising about 0.1% to about 50% hydrogen and at least one from the group of nitrogen and noble gases. The polymerized complex method may produces material with better purity, homogeneity, and morphology.

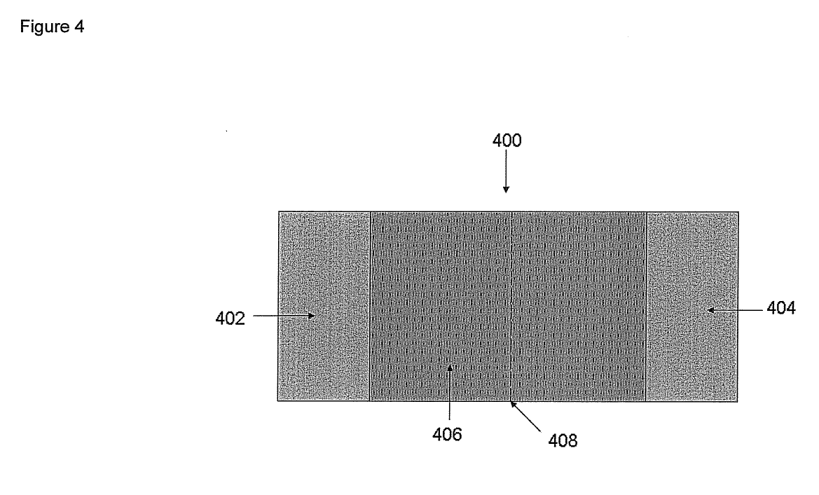

The substituted lithium titanate spinels described herein are useful in construction of electrochemical cells and specifically rechargeable lithium ion batteries. Binders, electrolytes, solvents, insert materials, cathode materials, means of venting, and other aspects of lithium ion electrochemical cells are well-known in the art. The novel substituted lithium titanate spinels described herein can be incorporated into a variety of electrochemical cell designs. FIG. 4 shows an embodiment electrochemical cell 400. The cell 400 comprises an anode 402 and a cathode 404. The anode 402 may be any of the novel, substituted lithium titanate spinels disclosed herein. The cathode 404 can be any of the materials commonly used in the art for such purposes including, but not limited to, lithium manganese oxide (LiMn₂O₄), lithium zinc manganese oxide (LiZnMnO₄), lithium cobalt oxide (LiCoO₂) and the like. The anode 402 and cathode 404 are separated by an electrolyte 406, such as lithium salts in an organic solvent or lithium salts in a polymer such as polyacrylonitrile. The electrolyte 406 allows for lithium ion conductance between the anode 402 and cathode 404. A selectively conducting, lithium-permeable separator 408 also separates the anode 402 from the cathode 404.

Rechargeable lithium ion battery designs that can benefit from the substituted lithium titanate spinels described herein includes U.S. Pat. Nos. 5,244,757; 5,587,253; 5,571,634; 5,296,318; 5,470,357; 5,498,489; 7,138,208; 7,008,722; 7,014,666; and 7,06011; which are all incorporated herein by reference. Uses for lithium ion batteries include consumer electronics such as camcorders, cell phones, notebook computers, digital cameras and the like, and also includes applications requiring higher power density such as electric vehicles, gas-electric hybrid vehicles, power tools, and military applications and equipment.

With respect to any figure or numerical range for a given characteristic, a figure or a parameter from one range may be combined with another figure or a parameter from a different range for the same characteristic to generate a numerical range.

While the invention has been explained in relation to certain embodiments, it is to be understood that various modifications thereof will become apparent to those skilled in the art upon reading the specification. Therefore, it is to be understood that the invention disclosed herein is intended to cover such modifications as fall within the scope of the appended claims.

What is claimed is:

1. An electrode comprising a lithium titanate spinel having one formula selected from the group of formulae:
Li₄Ti₅₋ₓMₓO₁₂,
Li₄Ti_{5-Z}M¹_{z1}M²_{z2}M³_{z3} . . . M^{k}_{zk}O₁₂,
Li₄Ti_{5-x-b}MₓB_{b}O₁₂,
Li₃₊ₐTi₆₋ₐ₋ₓMₓO₁₂,
Li₃₊ₐTi_{6-a-x-b}MₓB_{b}O₁₂, and
Li_{4-c}Mg_{c}Ti₅₋ₓMₓO₁₂;
wherein Z has a value from about 0.1 to about 2.5;
z1, z2, z3, . . . zk independently have a value from about 0 to about 2.5;
Z and z1, z2, z3, . . . zk satisfy the equation:
Z=z1+z2+z3+ . . . zk;
x has a value from about 0.1 to about 2.5, a has a value from about 0 to about 1, b has a value from about 0 to about 2.5, and c has a value from about 0 to about 1.5;
M is one or more cations selected from the group of V, Cr, Nb, Mo, Ta, and W;
M¹, M², M³, . . . M^{k} are cations independently selected from the group of V, Cr, Nb, Mo, Ta, and W; and
B is one or more cations selected from the group of Zr, Ce, Si, and Ge.

2. The electrode of claim 1 wherein the lithium titanate spinel further comprises one formula selected from the group of Li₄Ti₅₋ₓMoₓO₁₂, Li₄Ti₅₋ₓNbₓO₁₂ and Li₄Ti₅₋ₓVₓO₁₂ where x has a value from about 0.1 to about 2.5

3. The electrode of claim 1 wherein M represents a mixture of two or more cations selected from the group of V, Cr, Nb, Mo, Ta, and W, wherein the cations have an average oxidation state of at least about 3+ to at most about 6+.

4. The electrode of claim 1 wherein M and M¹, M², M³ . . . M^{k} have an average oxidation state in the range of at least about 3+ and at most about 6+.

5. The electrode of claim 1 wherein B has an average oxidation state in the range of at least about 3+ and at most about 4+.

6. The electrode of claim 1 wherein Ti has an average oxidation state of at least about 3+ to at most about 4+.

7. The electrode of claim 1 wherein the spinel has a crystal structure defined by Space Group Fm3d, wherein about 1/50th or less of M and M¹, M², M³ . . . M^{k} occupy site 8a and sites crystallographically equivalent to site 8a, and wherein a majority of M and M¹, M², M³ . . . M^{k} occupy site 16d and sites crystallographically equivalent to site 16d.

8. The electrode of claim 1 wherein a Cu—Kα powder x-ray diffraction pattern has a first peal, intensity that indexes to a crystal plane 111 and in the vicinity of 2θ=18.4° and a second peak intensity that indexes to crystal plane 220 and in the vicinity of 2θ=30.2°, wherein the second peal (intensity is about 1/50th or less of the first peak intensity.

9. The electrode of claim 1 wherein the lithium titanate spinel has a phase pure crystalline form.

10. A rechargeable lithium ion electrochemical cell comprising:
a negative electrode member comprising a first electrochemically active material;
a positive electrode member comprising a second electrochemically active material;
an electrolyte comprising a lithium salt allowing for lithium ion conductance between the negative electrode and the positive;
a lithium-permeable separator located between the negative electrode and the positive electrode; and
wherein at least one of the first electrochemically active material or the second electrochemically active material comprises a lithium titanate electrode of claim 1.

11. A method for making a lithium titanate spinel comprising:
contacting titanium oxide, lithium titanate spinel, and at least one species of lithium metal oxide comprising one or more cations from the elements V, Cr, Nb, Mo, Ta, and W; and
heating to a temperature of at least about 600° C. to at most about 1100° C. under an atmosphere comprising about 0.1% to about 50% hydrogen and at least one selected from the group of nitrogen and noble gases, or comprising about 1% to about 70% carbon monoxide and at least one selected from the group of carbon dioxide, nitrogen and noble gases.
